(19) United States
(12) Patent Application Publication
(10) Pub. No.: US 2002/0019940 A1
(43) Pub. Date: Feb. 14, 2002

(54) Method and apparatus for assigning test and assessment instruments to users

(76) Inventors: Craig S. Matteson, Ann Arbor, MI (US); Calvin D. Longton, Northville, MI (US)

Correspondence Address: William J. Clemens, MacMillan, Sobanski, & Todd, LLC, One Maritime Plaza, Fourth Floor, 720 Water Street, Toledo, OH, 43604, US

(21) Appl. No.: 09/880,304

(22) Filed: Jun. 13, 2001

Related U.S. Application Data
(60) Provisional application No. 60/212,473, filed on Jun. 16, 2000.

(51) Int. Cl. H04K 1/00

(52) U.S. Cl. 713/184

(57) ABSTRACT

A method and apparatus for remotely providing survey assessment instruments to users includes selecting one or more instruments, a user identification and a personal identification number and associated those components into an experience. The experience is stored in a database that is remotely accessed by a user who has been provided with the user identification and the personal identification number. Upon confirmation of the association, the user is permitted to access the experience which access can be controlled by associated rule and threshold settings.

### BACKGROUND OF THE INVENTION

The present invention relates generally to a method and apparatus to be used for human resources and employee development and, in particular, to a method and apparatus for assigning test and assessment instruments to users.

Employee development and assessment tests are well known. Employers have used these tests to screen internal and external applicants for job postings, to assess employee development, and as a means for allowing employees to advance to higher job levels. The tests generally consist of questions presented in a multiple choice format. Employees are often required to pass certain assessment tests in order to be eligible or to be considered for job promotions. Many of these tests have been administered by human resources personnel, and have been paper-based tests. One of the many disadvantages of the paper-based tests is that they must be graded by the human resources personnel or sent to an external resource for grading. Human intervention clearly introduces the possibility of errors, as well as a lack of speed. When employees are relying on the results of the test as a means for advancement, speed is especially critical. Machine-grading tests, utilizing “Scantron®” type answer sheds or the like, can increase the speed and accuracy of grading, but it remains a time-consuming process. After grading, the results then had to be manually entered into a database or filed within the human resources department.

An obvious solution to the speed and accuracy problems noted above was to create computer software programs with which to conduct the tests. The software program carried out and administered the test, completed the grading instantaneously, and, advantageously, had no paper to lose. Companies have developed tests on their own, or have purchased copies of software programs from third party software development companies. If the companies used third party software, however, the companies were limited to using those computers that contained the licensed copies of the software.

Not unexpectedly, after stand-alone computer software programs were developed, web-based applications followed. These web-based applications represented a further improvement in that all that was required to take the test was a web browser, commonly provided with most computers. These tests, therefore, could be taken at any location, and were not limited to those company computers that contained the only available licensed copies of the software. Employers, for example, could use the tests to screen job applicants before bringing the applicants in for interviews.

Web-based prior art testing programs, however, also have some limitations and disadvantages. There are times, for example, when an employer wishes to present a person with multiple tests, surveys, or assessments. Tests, surveys, and assessments are collectively referred to as instruments. No present web-based method of presenting instruments allows for the presentation of multiple instruments as a single experience. A further complication is that the presentation of the multiple instruments may at times be conditional, or dependent on the score of the user. For example, if an applicant fails to achieve a score of seventy percent on the first instrument he should not be presented with the subsequent instruments. Since employment tests are often supplied by third parties and are charged for on a per-use basis, it is costly and inefficient to present these instruments unnecessarily. Prior art methods, whether paper based, stand-alone software, or web-based, do not allow for conditional presentation since they are not bound into a single presentation experience with set conditions, nor are they scored until after all the instruments are presented and all the responses collected.

Another problem noted in prior art systems is that none provide a dynamic means of letting a user take a specific instrument without some kind of user registration with the site before an instrument can be assigned. User registration raises a multitude of problems. One problem is that a large database of users must be maintained, which is particularly cumbersome when there are likely to be users who take an instrument only once. Another problem is the possibility of multiple database entries of the same item, for example, a user into a database with slightly different formations of the name. A more serious problem occurs when the wrong “John Smith” is assigned to an instrument. Requiring prior user registration also causes delays in launching instruments because each person assigned to take an instrument must be given an identification (ID) and password before the instrument can be associated with the ID and password. If the users must register themselves, they will create their own ID and password which may correspond to nothing in the company's data structure and may make the data hard to use in a way meaningful to the company.

Still another problem noted in prior art systems is when many types of instruments might need to be assigned to dozens, hundreds, or even thousands of users at a time. It is typically not a problem for an administrator to assign instruments to User IDs and link them to PINs to create an Experience for one, a few, or even a dozen users. Those situations in which many types of instruments need to be assigned to multiple users, however, require a tremendous amount of labor for paper methods and are not handled effectively by prior art software or web-based methods. Prior art methods do not scale well for large deployments nor do they handle the mass assignment of multiple instruments to users. In addition, the delivery of the necessary information to take the test, assessment, or survey is cumbersome at best.

It is desirable, therefore, to provide a web-based application that allows its users to create a suite of instruments from a multitude of possible instruments with instructions as to how to handle the conditions between the multiple instruments, present the combined instruments as a single instrument, and then assign the combined instruments to single or multiple test-takers. It is also desirable to be able to assign an instrument or the combined instruments to multiple test-takers simultaneously.

It is an object of the present invention to link multiple instruments and to handle them in alternative ways according to administrator determined rules and thresholds based upon user responses, including immediate tabulation of those responses.

It is another object of the present invention to provide a mechanism for a user who is not registered with the site to securely obtain a specific instrument of assessment in a manner that secures the instrument to only those with the User ID and Personal Identification Number (PIN) combination, assures that they can only get to the instrument once and only once, and combines these three elements (the User ID, PIN, and Instrument) in a way that creates a one time user experience.

It is still another object of the present invention to create experiences (the combination of User ID, PIN, and Instrument) in a batch mode by using user-supplied lists.

### SUMMARY OF THE INVENTION

The present invention concerns a method and apparatus for assigning test and assessment instruments (e.g. tests, surveys, or assessments) to users. When multiple instruments are grouped together, the combined instruments are referred to as an instrument suite. The present invention provides a means of creating an instrument suite and then presenting the instrument suite as if it were a single instrument. The present invention accomplishes this by not only providing the ability to create new instruments but also by allowing an administrator to gain access to third party copyrighted instruments by entering a consultant code given them by the authorized third party. If there is a need to present more than one instrument, whether self-created, third party, or a combination of both types of instruments, the present invention is able to combine the instruments, regardless of their type, into an instrument suite. The present invention further tracks and reports each use of third party instruments to the third party test owners and the appropriate consultants and administrators.

The present invention contemplates that the users will enter the suite in the same manner whether their suite contains a single instrument or a battery of instruments. The users will not know whether they are facing a single instrument or multiple instruments when they start. In this way, if the users are not presented subsequent instruments, they will not realize or have questions about why they were not given all the instruments prepared for them.

The novelty of the present invention is also shown in its additional ability to assign (or not assign) conditions on the presentation of these instruments to the user. The present invention contemplates that each instrument within the instrument suite can be given thresholds and conditions that will be used by the present invention's process to determine which instruments are presented to the user. If the thresholds are met or exceeded, the next assigned instrument is presented. If the threshold is not met, the process will follow the instructions for presenting a different instrument or end the presentation process. Regardless of whether the predetermined thresholds are met or not met, the present invention presents the subsequent instrument(s) in a manner that is seamless and requires no further action or input on the part of the user. The various instructions and the exit process are also handled in such a manner that the user perceives no difference between an abbreviated suite and an entire instrument suite. The users do not perceive that they are taking multiple instruments because the present invention represents the questions in the same format. That is, the format of the questions, including the color of the screen, is presented in the same manner regardless of which instrument is being presented so that it appears to the user that it is a single instrument. The only way users could know that they were going to take multiple instruments is if the administrator provides them that information. The administrator is thus given complete flexibility in the manner of presentation and it is their choice to set conditions or not.

The conditional presentation of instruments also includes the ability to immediately tabulate an instrument. The instrument would be immediately tabulated to test administrator assigned conditions and thresholds to determine the instruction set for the present invention's processes to use in handling the subsequent experience presentation to the user.

After the instrument suite has been created, the present invention next provides a novel means of assigning the instrument suite to users. The present invention accomplishes this by allowing an administrator to create or select an instrument or instrument suite and to link a specific user identification (User ID) to that instrument or instrument suite. This User ID is preferably one that is meaningful to the company, for example a name, a computer ID, a Social Security Number, or an employee number. The present invention next allows the administrator to associate the User ID with a personal identification number (PIN) chosen by the administrator or generated by the present invention. This fusion of instrument or instrument suite, User ID and PIN creates what is referred to as an experience. The experience is then stored as a record in a database, referred to as the single experience database. The present invention is then able to present the user with a single experience that is based upon their User ID and PIN and the instrument or instrument suite linked to that User ID and PIN as if it were an experience consisting of a single instrument. The User ID and PIN given to the user provide access to the assigned instrument and only that assigned instrument via a provided web site.

The combination of the instrument, User ID and PIN allows a user who has never registered with the web site and who may only be a job applicant to the company presenting the instrument, to enter the web site, enter the User ID and PIN given to him and be presented with the specific instrument assigned to him by the company's administrator. The user comes to the web site and is not required to select anything, register anything, or do anything but come to the URL via a standard web browser. After the user enters the user ID and PIN, the present invention matches the user ID and PIN with a record in the single experience database and provides the specific instrument to the user. This PIN is used only once for the single experience of taking this instrument suite by entering the User ID and associated PIN. If the user is to take another instrument suite on a different occasion, the User ID may be reused but a different PIN will be generated and associated with that combination of instrument suite and User ID.

The present invention allows for immediate launching of instruments, quick turn around of user participation in taking the instrument, and it does so in a secure environment because even if the User ID is compromised it is unlikely that the PIN can be guessed. Since the PIN is a single use device it is of no use to anyone once it has been used for the single experience for which it was created and assigned.

The present invention also offers the administrator the flexibility of creating individual experiences for each user or assigning experiences to as many users as desired at a single time. The present invention accomplishes this by the administrator selecting the option for batch handling of User IDs, after the administrator has created the instrument suite. The desired User IDs are then pasted into the present invention's web site in a specified format, such as ASCII delimited text or comma-separated text. Depending on the services the administrator wishes the present invention to perform they may select various formats including the simple assignment of PINs to User IDs for a specified instrument or Instrument Suite. To do this User IDs alone are pasted into the web site. They are checked for proper formatting and the administrator is given information to check if their supplied information is being read correctly. Once the administrator approves the information, each User ID is assigned a PIN. The administrator can then download the User ID and PIN information so that the information can be distributed to the appropriate users through their own resources.

Alternatively, the administrator can have the present invention e-mail the user with the information necessary to take the experience, by pasting in User IDs and e-mail addresses in a specified format on the present invention's web site. The administrator is informed about the information that can be approved or corrected by the administrator. Once the information is approved a PIN is assigned to each User ID. The administrator is also presented with a sample of the e-mail message that will be sent to each user of the experience. The administrator can customize the e-mail message before it is sent. The administrator can also determine a range of dates and times for the e-mail messages to be sent.

The e-mail messages are then sent to the users based upon the information supplied and according to the rules applied by the administrator. The instrument or instrument suite is then linked to the User IDs and PINs to create the experience each user will take and to create the corresponding number of records in the single experience database. Users then come to the present invention's web site, enter their User ID and PIN and are presented with the instrument or instrument suite prepared for them.

These processes will enhance the administrator's flexibility in the way experiences are created for the users and how the present invention is enlisted to provide extra services. By allowing multiple data formats based upon the services desired and the ability to download data for use of the company's own resources, the present invention allows the administrator to select the level of service the company will provide for itself or to utilize services from the present invention.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a flow diagram of a method for creating and presenting an instrument as a single instrument in accordance with the present invention;

FIG. 2 is a flow diagram of a method for assigning a single instrument to users in accordance with the present invention;

FIG. 3 is a flow diagram of a method for simultaneously assigning an instrument or instrument suite to many users in accordance with the present invention; and

FIG. 4 is a schematic block diagram of an apparatus for performing the methods according to the present invention.

### DESCRIPTION OF THE PREFERRED EMBODIMENT

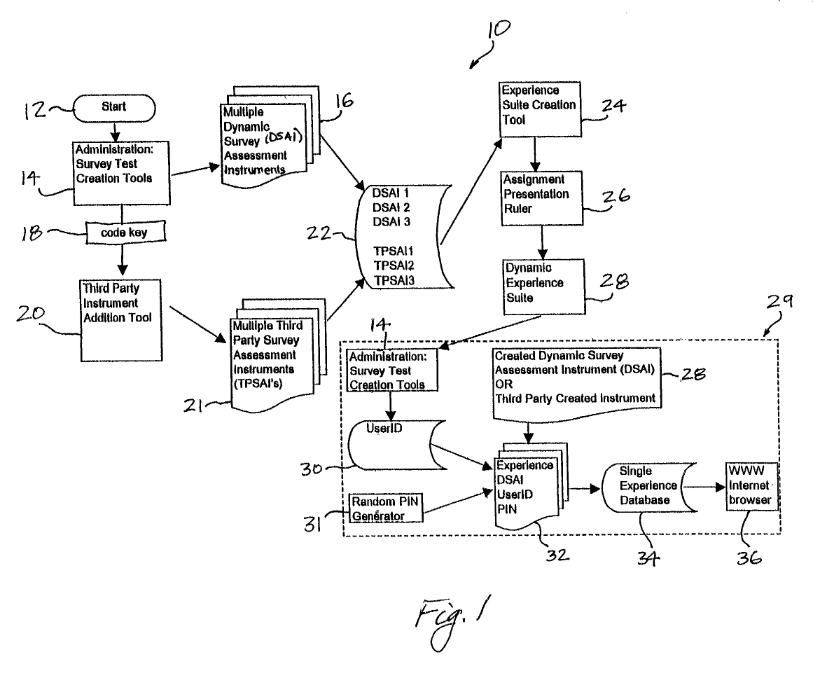

Referring to FIG. 1, a method for creating and presenting an instrument as a single instrument is indicated generally at 10. An instrument is defined as a test, survey, or assessment device. The administrator (not shown), likely a human resources employee of a company utilizing the method 10, enters at a “Start step” 12. The administrator then utilizes survey test creation tools (step 14) to create and save (step 16) at least one dynamic survey assessment instrument (DSAI). In addition, the administrator can enter a code key (step 18) to utilize a third party instrument addition tool (step 20) and thereby add (step 21) at least one third party survey assessment instrument (TPSAI). Each of the DSAIs and the TPSAIs, if applicable, are combined (step 22) to complete an instrument suite.

The administrator then proceeds to an instrument suite creation tool (step 24) to set assignment presentation rules (step 26), including, but not limited to, scoring thresholds, the order of instrument presentation, and other conditional rules, such as which instrument should be presented after a certain score on another instrument, and when the instrument should be terminated. Numerous logical rules and variations of the rules can be appreciated by those skilled in the art. After setting all the conditional rules to complete the step 26, the administrator saves the DSAIs, the TPSAIs, and the rules as an instrument suite (step 28.) The administrator can do this with only one DSAI or one TPSAI, or can include as many DSAIs, TPSAIs, or rules as the administrator deems necessary.

The administrator, in steps 14 through 28, has now created an instrument suite for presentation to company employees, job seekers, or the like. The administrator next proceeds to create an experience, shown generally at 29, when the administrator desires to present the instrument suite to an individual (user). The administrator creates (step 30) a user identification code (User ID) for each user. The User ID is preferably one that is meaningful to the company, for example a name, a computer ID, a Social Security number, or an employee number. The method 10 according to the present invention then generates a random personal identification number code (PIN) (step 31). Alternatively, the administrator can create a PIN. The User ID, the PIN, and the instrument suite are then combined (step 32) into an experience, which is saved as a record (step 34) in a single experience database. The database (step 34) is connected to a selected web site (not shown), which can be accessed through a World Wide Web Internet browser (step 36.)

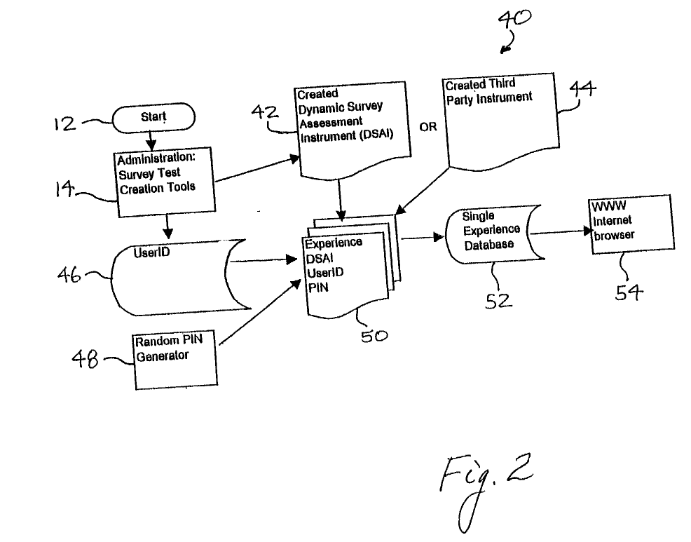

Referring to FIG. 2, an alternate method according to the present invention for assigning a single instrument to users is indicated generally at 40. The administrator utilizes the method 40 to assign a single instrument, rather than an instrument suite, to a user or users. The administrator selects a DSAI (step 42) or a TPSAI (step 44) and assigns a user ID (step 46). The present invention then generates a random PIN (step 48), or alternatively, the administrator can create a PIN. The administrator then combines the DSAI or the TPSAI, the User ID and the PIN into a user experience in step 50. The user experience is saved as a record (step 52) in a single experience database. Note that no rules are assigned to the experience, because only one instrument has been assigned to the User ID. The database in step 52 is connected to the web site (not shown), which can be accessed by a World Wide Web Internet browser (step 54), as in FIG. 1.

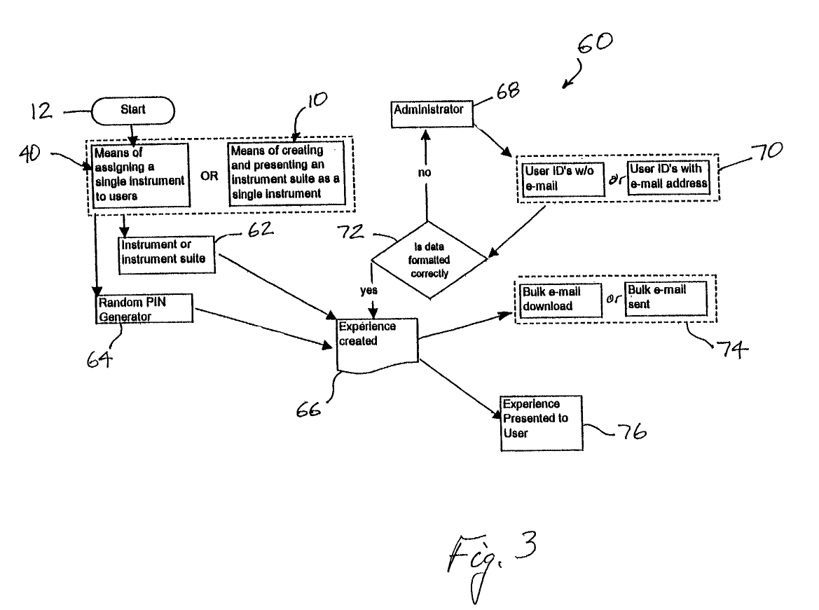

Referring to FIG. 3, a method according to the present invention for simultaneously assigning an instrument or instrument suite to many users is indicated generally at 60. The method 60 is optionally implemented after either method 10 or the method 40 has been completed, and an instrument or instrument suite has been created, noted by step 62. The PIN generation of the previously described method steps 30 and 48 is shown at a step 64, and the experience creation of the previously described method steps 32 and 50 is shown at a step 66. In order for the User IDs to be associated with PINs, the administrator (step 68) creates the User IDs in one of two formats. The administrator can create (step 70) a list of User IDs without e-mail addresses or a list of User IDs with e-mail addresses. The administrator preferably supplies the User IDs by pasting the User IDs onto the web site (not shown.) The User IDs are checked for the proper format (step 72), and if they are in a proper format, the experience is created by combining the User IDs, the PINs and the instrument or the instrument suite in a step 66. If the User IDs are not in the proper format, the data is sent back to the administrator for reformatting in steps 68 and 70, are rechecked for proper formatting in step 72, and if properly formatted, then sent on to create the experience in step 66.

After the experience is created in step 66, the administrator notifies (not shown) the users of their User IDs and PINs via a bulk e-mail download or similar methods in a step 74. Alternatively, the method according to the present invention sends (in step 74) a bulk e-mail mailing to each e-mail address supplied with the User IDs, providing the users with their User IDs and PINs. After the experience creation of step 66, the records are entered into the single experience database (not shown) and the experience is presented to the user in a step 76 when he or she logs in to the associated web site (not shown) via a browser (not shown.).

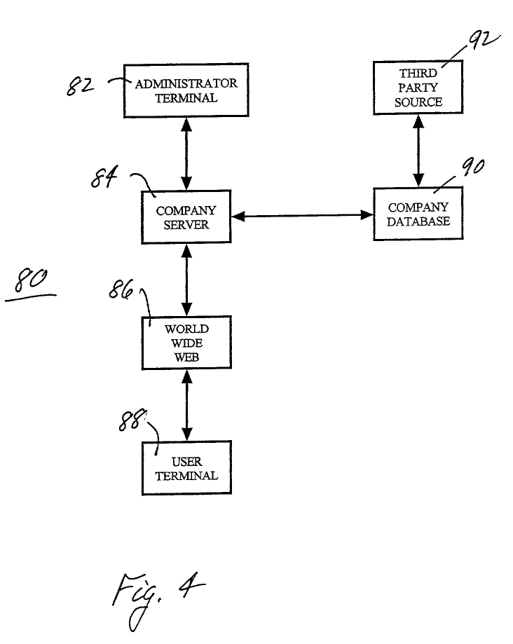

A system 80 for implementing the methods 10, 40 and 60 is shown in the FIG. 4. The administrator operates an administrator terminal 82 that is connected to a company server 84 supporting the associated web site. The server 84 is selectively connected via the World Wide Web 86 to a user terminal 88 to present an experience to a user. The experiences are stored in a company database 90 connected to the server 84. The administrator creates experiences using DSAIs and/or TPSAI and/or rules. A third party source 92 is shown as being connected to the database 90 to provide TPSAIs. However, the source 92 may instead be connected to the World Wide Web 86 or provide the TPSAIs to the administrator to be entered through the terminal 82.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method of creating and presenting a testing experience to a user comprising the steps of:
a) selecting at least one survey assessment instrument;
b) selecting a user identification code (User ID);
c) selecting a personal identification number code (PIN);
d) associating the at least one instrument, the User ID and the PIN to create an experience;
e) storing the experience in a database;
f) providing the User ID and the PIN to a selected user;
g) providing access to the database through a web site;
h) upon connection of the selected user to the web site and entry of the User ID and the PIN by the selected user, confirming the association of the User ID with the PIN; and
i) permitting the selected user to remotely view and interact with the at least one instrument after confirmation of association of the User ID and the PIN.

2. The method according to claim 1 wherein step a) is performed by creating a dynamic survey assessment instrument (DSAI) as the at least one survey assessment instrument.

3. The method according to claim 1 wherein step a) is performed by obtaining a third party survey assessment instrument (TPSAI) as the at least one survey assessment instrument.

4. The method according to claim 1 including associating rule and threshold settings with the at least one instrument in the experience.

5. The method according to claim 4 including creating the rule and threshold settings as at least one of instrument score limits, order of the instrument presentation, conditional order of the instrument presentation and experience termination guidelines.

6. The method according to claim 1 including performing the steps b), c), d), f), h) and i) for each of a plurality of selected users.

7. The method according to claim 1 including performing the step a) by selecting at least one other survey assessment instrument and performing the step d) by associating the at least one other survey assessment instrument with the at least one instrument, the User ID and the PIN to create the experience.

8. The method according to claim 1 wherein step c) is performed by generating the PIN with a random PIN generator.

9. The method according to claim 1 wherein the step f) is performed by sending the User ID and the PIN to the selected user in an e-mail message.

10. A method of creating and presenting a testing experience to a user comprising the steps of:
j) selecting at least two survey assessment instruments;
k) selecting a user identification code (User ID);
l) selecting a personal identification number code (PIN);
m) associating the at least two instruments, the User ID and the PIN to create an experience;
n) storing the experience in a database;
o) providing the User ID and the PIN to a selected user;
p) providing access to the database through a web site;
q) upon connection of the selected user to the web site and entry of the User ID and the PIN by the selected user, confirming the association of the User ID with the PIN; and
r) permitting the selected user to remotely view and interact with the at least two instruments after confirmation of association of the User ID and the PIN.

11. An apparatus for creating and presenting a testing experience to a remotely located user comprising:
a means usable by an administrator for selecting at least one survey assessment instrument, a user identification code (User ID) and a personal identification code (PIN) and associating said at least one instrument, said User ID and said PIN in an experience;
a means for storing the experience connected to said means for selecting; and
a means for maintaining a web site connected to said means for storing whereby when a user accesses the web site with the User ID and PIN, said means for maintaining confirms the association of the User ID with the PIN and permits the user to remotely view and interact with the at least one instrument after confirmation of the association of the User ID and the PIN.

12. The apparatus according to claim 11 wherein said means for selecting permits the administrator to include rule and threshold settings with said experience.

13. The apparatus according to claim 12 wherein said rule and threshold settings include at least one of instrument score limits, the order of the instrument presentation, the conditional order of the instrument presentation and experience termination guidelines.

14. The apparatus according to claim 11 wherein the at least one instrument is a dynamic survey assessment instrument.

15. The apparatus according to claim 11 wherein the at least one instrument is a third party survey assessment instrument.
